(19) United States
(12) Patent Application Publication
(10) Pub. No.: US 2025/0329493 A1
(43) Pub. Date: Oct. 23, 2025

(54) MULTILAYER CERAMIC CAPACITOR AND METHOD FOR MANUFACTURING THE SAME

(71) Applicant: Murata Manufacturing Co., Ltd., Nagaokakyo-shi (JP)

(72) Inventor: Kazuto FUJISAWA, Nagaokakyo-shi (JP)

(21) Appl. No.: 19/030,359

(22) Filed: Jan. 17, 2025

(30) Foreign Application Priority Data
Apr. 22, 2024 (JP) 2024-068812

(51) Int. Cl. H01G 4/005; H01G 4/12; H01G 4/232; H01G 4/248; H01G 4/30

(52) U.S. Cl. CPC H01G 4/005; H01G 4/1209; H01G 4/2325; H01G 4/248; H01G 4/30

(57) ABSTRACT

A multilayer ceramic capacitor includes a multilayer body including, in a cross section taken along a layer stacking direction and a widthwise direction at a middle portion of the multilayer body in a lengthwise direction, internal electrode layers each including opposite ends in the widthwise direction with one opposite end arcuately curved to include an arcuate portion and the other opposite end bent to include a bent portion including at least one point of inflection. The internal electrode layers include a type-A internal electrode layer including one end in the widthwise direction with the arcuate portion, and a type-B internal electrode layer including the one end in the widthwise direction with the bent portion.

### CROSS REFERENCE TO RELATED APPLICATIONS

This nonprovisional application is based on Japanese Patent Application No. 2024-068812 filed on Apr. 22, 2024 with the Japan Patent Office, the entire contents of which are hereby incorporated by reference.

### BACKGROUND OF THE INVENTION

### 1. Field of the Invention

The present invention relates to multilayer ceramic capacitors and methods for manufacturing the same.

### 2. Description of the Background Art

Japanese Patent Laid-Open No. 2023-35851 is a prior art document disclosing a configuration of a ceramic electronic component. Japanese Patent Laid-Open No. 2023-35851 discloses a process for manufacturing the ceramic electronic component and in that process, on a dielectric green sheet at a peripheral region with no electrode pattern printed therein a paste of an inverted pattern is printed to dispose a first pattern to fill a step from the electrode pattern.

In recent years, multilayer ceramic capacitors are increasingly miniaturized, and it is difficult to accurately and rapidly dispose a dielectric pattern around a conductive pattern for filling a step. As a result, there may result an unexpected gap between the dielectric pattern and the conductive pattern and an unexpected overlap between the dielectric pattern and the conductive pattern. When these gap and overlap are excessively continuously introduced one on the other, the resultant multilayer ceramic capacitor will have a structural defect.

### SUMMARY OF THE INVENTION

Example embodiments of the present invention provide multilayer ceramic capacitors and methods for manufacturing the same, which each prevent structural defects.

A multilayer ceramic capacitor according to an example embodiment of the present invention includes a multilayer body and an external electrode. The multilayer body includes a plurality of dielectric layers and a plurality of internal electrode layers that are stacked in a layer stacking direction, and includes a first major surface and a second major surface opposite to each other in the layer stacking direction, a first side surface and a second side surface opposite to each other in a widthwise direction orthogonal to the layer stacking direction, and a first end surface and a second end surface opposite to each other in a lengthwise direction orthogonal to both the layer stacking direction and the widthwise direction. The external electrode is provided on each of the first and second end surfaces and is connected to the plurality of internal electrode layers. In a cross section of the multilayer body taken along the layer stacking direction and the widthwise direction at a middle portion of the multilayer body in the lengthwise direction, the plurality of internal electrode layers each include opposite ends in the widthwise direction with one opposite end arcuately curved to include an arcuate portion and the other opposite end bent to include a bent portion including at least one point of inflection. The plurality of internal electrode s include a type-A internal electrode layer including one end in the widthwise direction with the arcuate portion, and a type-B internal electrode layer including the one end in the widthwise direction with the bent portion.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of an appearance of a multilayer ceramic capacitor according to a first example embodiment of the present invention.

FIG. 2 is a cross section of the multilayer ceramic capacitor of FIG. 1 as seen in the direction of an arrow II-II.

FIG. 3 is a cross section of the multilayer ceramic capacitor of FIG. 1 as seen in the direction of an arrow III-III.

FIG. 4 is a cross section of the multilayer ceramic capacitor of FIG. 2 as seen in the direction of an arrow IV-IV.

FIG. 5 is a cross section of the multilayer ceramic capacitor of FIG. 2 as seen in the direction of an arrow V-V.

FIG. 6 is a perspective view of an appearance of an inner layer ceramic green sheet with a conductive pattern formed thereon to serve as a raw material sheet in a method for manufacturing a multilayer ceramic capacitor according to the first example embodiment of the present invention.

FIG. 7 is a plan view of an appearance of an inner layer ceramic green sheet with a dielectric pattern formed thereon to serve as a raw material sheet in the method for manufacturing the multilayer ceramic capacitor according to the first example embodiment of the present invention.

FIG. 8 shows an outer layer ceramic green sheet and the raw material sheet stacked in layers in the method for manufacturing the multilayer ceramic capacitor according to the first example embodiment of the present invention.

FIG. 9 shows a multilayer ceramic capacitor according to a second example embodiment of the present invention in a cross section taken along a layer stacking direction and a widthwise direction at a middle portion in a lengthwise direction.

FIG. 10 shows an outer layer ceramic green sheet and a raw material sheet stacked in layers in a method for manufacturing a multilayer ceramic capacitor according to the second example embodiment of the present invention.

### DETAILED DESCRIPTION OF THE EXAMPLE EMBODIMENTS

Hereinafter, a multilayer ceramic capacitor according to each of example embodiments of the present invention will be described with reference to the drawings. In the drawings, identical or equivalent components will identically be denoted, and will not be described repeatedly in the following description of the example embodiments.

### First Example Embodiment

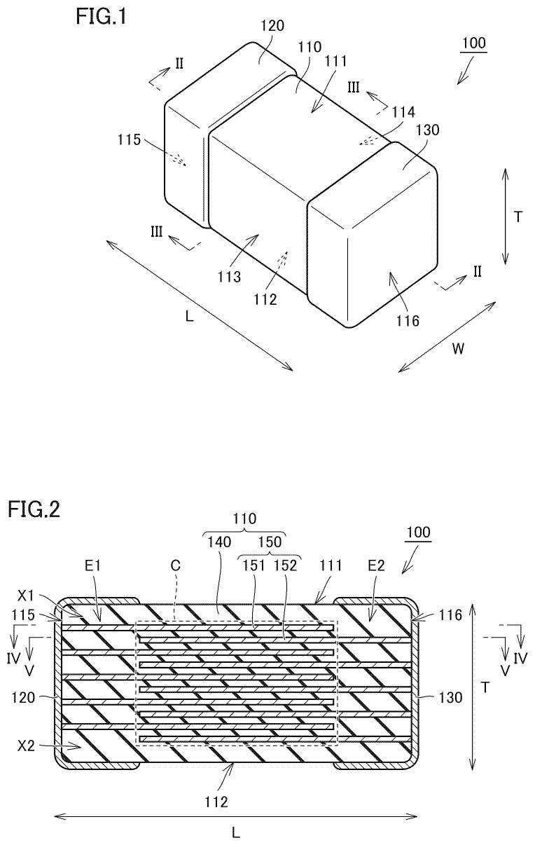

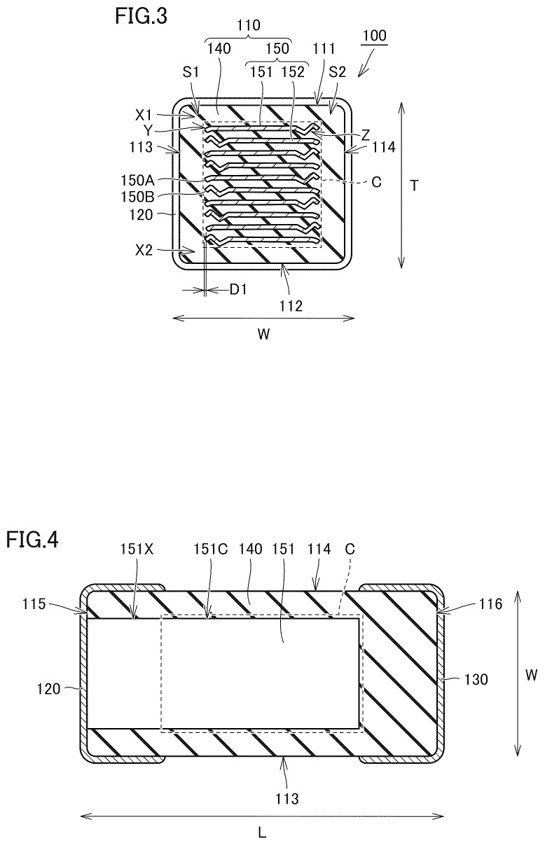

FIG. 1 is a perspective view of an appearance of a multilayer ceramic capacitor according to a first example embodiment of the present invention. FIG. 2 is a cross section of the multilayer ceramic capacitor of FIG. 1 as seen in the direction of an arrow II-II. FIG. 3 is a cross section of the multilayer ceramic capacitor of FIG. 1 as seen in the direction of an arrow III-III. FIG. 4 is a cross section of the multilayer ceramic capacitor of FIG. 2 as seen in the direction of an arrow IV-IV. FIG. 5 is a cross section of the multilayer ceramic capacitor of FIG. 2 as seen in the direction of an arrow V-V. In FIGS. 1 to 5, a multilayer body, which will be described hereinafter, has a length in a direction L and a width in a direction W, and has layers stacked in a direction T.

As shown in FIGS. 1 to 5, a multilayer ceramic capacitor 100 according to the first example embodiment of the present invention includes a multilayer body 110, a first external electrode 120, and a second external electrode 130. Multilayer body 110 includes a plurality of dielectric layers 140 and a plurality of internal electrode layers 150 alternately stacked in layer stacking direction T.

Multilayer body 110 includes a first major surface 111 and a second major surface 112 opposite to each other in layer stacking direction T, a first side surface 113 and a second side surface 114 opposite to each other in widthwise direction W orthogonal to layer stacking direction T, and a first end surface 115 and a second end surface 116 opposite to each other in lengthwise direction L orthogonal to both layer stacking direction T and widthwise direction W. First external electrode 120 is provided on first end surface 115. Second external electrode 130 is provided on second end surface 116.

The plurality of internal electrode layers 150 include a plurality of first internal electrode layers 151 connected to first external electrode 120 and a plurality of second internal electrode layers 152 connected to second external electrode 130. Although FIGS. 2 and 3 show an example in which five first internal electrode layers 151 and five second internal electrode layer 152 are provided, first and second internal electrode layers 151 and 152 are not limited in number to five layers.

As shown in FIG. 4, first internal electrode layer 151 includes a facing portion 151C that faces second internal electrode layer 152, and a lead portion 151X that is led out to first end surface 115. As shown in FIG. 5, second internal electrode layer 152 includes a facing portion 152C that faces first internal electrode layer 151, and a lead portion 152X that is led out to second end surface 116.

As shown in FIGS. 2 to 5, multilayer body 110 is sectionalized by an inner layer portion C, a first outer layer portion X1 and a second outer layer portion X2, a first side margin portion S1 and a second side margin portion S2, and a first end margin portion E1 and a second end margin portion E2.

Inner layer portion C includes first and second internal electrode layers 151 and 152 with their respective facing portions 151C and 152C stacked in layers in layer stacking direction T to have a capacitance. First outer layer portion X1 is located on a side of inner layer portion C closer to first major surface 111 in layer stacking direction T. Second outer layer portion X2 is located on a side of inner layer portion C closer to second major surface 112 in layer stacking direction T.

First side margin portion S1 is located on a side of inner layer portion C closer to first side surface 113 in widthwise direction W. Second side margin portion S2 is located on a side of inner layer portion C closer to second side surface 114 in widthwise direction W. First end margin portion E1 is located on a side of inner layer portion C closer to first end surface 115 in lengthwise direction L. Second end margin portion E2 is located on a side of inner layer portion C closer to second end surface 116 in lengthwise direction L.

Multilayer body 110 preferably has rounded corners and ridges. As referred to herein, a corner is a portion where three surfaces of multilayer body 110 meet, and a ridge is a portion where two surfaces of multilayer body 110 meet.

Dielectric layer 140 located in inner layer portion C preferably has a thickness of about 0.3 μm or more and about 0.8 μm or less, for example. First and second outer layer portions X1 and X2 each preferably have a thickness of about 10 μm or more and about 30 μm or less, for example. First and second side margin portions S1 and S2 each preferably have a width of about 0.1 μm or more and about 0.5 μm or less, for example. First and second end margin portions E1 and E2 each preferably have a length of about 0.2 mm or more and about 1.0 mm or less, for example. The thickness of dielectric layer 140 located in inner layer portion C, the thickness of each of first and second outer layer portions X1 and X2, and the length of each of first and second end margin portions E1 and E2 are dimensions at the location of a middle portion of multilayer body 110 in widthwise direction W. The width of each of first and second side margin portions S1 and S2 is a dimension at a location of a middle portion of multilayer body 110 in lengthwise direction L.

The plurality of dielectric layers 140 each include dielectric grains having a perovskite structure such as BaTiO₃, CaTiO₃, SrTiO₃ or CaZrO₃ as a major ingredient. The plurality of dielectric layers 140 may each include in the above major ingredient a subordinate ingredient of at least one of a Si compound, a Mg compound, a Mn compound, a Fe compound, a Cr compound, a Ni compound, or a Co compound included in an amount smaller than that of the major ingredient.

First and second internal electrode layers 151 and 152 each include one type of metal including Ni, Cu, Ag, Pd or Au, or an alloy including the metal. First and second internal electrode layers 151 and 152 may further include dielectric grains of the same type in composition as a ceramic material included in dielectric layer 140. In addition, Sn may be present at an interface between each of first and second internal electrode layers 151 and 152 and dielectric layer 140.

First and second internal electrode layers 151 and 152 preferably each have a thickness of about 0.3 μm or more and about 0.8 μm or less, for example. Internal electrode layers 150 including first and second internal electrode layers 151 and 152 are preferably 10 or more and 1,000 or less internal electrode layers, for example.

A thickness of dielectric layer 140, and first and second internal electrode layers 151 and 152 can be measured in the following method.

Initially, multilayer body 110 is ground to expose a plane thereof defined by layer stacking direction T and widthwise direction W of multilayer body 110, that is, a plane thereof orthogonal to lengthwise direction L, and the exposed cross section is observed with a scanning electron microscope. Subsequently, dielectric layer 140 is measured in thickness on a center line passing through a center of the exposed cross section and extending in layer stacking direction T and two lines drawn on either side equidistantly from the center line for a total of five lines. An average value of these five measured values serves as the thickness of dielectric layer 140.

A thickness of first and second internal electrode layers 151 and 152 can also each be measured in a method similar to the method for measuring the thickness of dielectric layer 140, in the same cross section as that in which the thickness of dielectric layer 140 is measured, with a scanning electron microscope.

First external electrode 120 is formed on the entirety of first end surface 115 of multilayer body 110 and is also formed to wrap around multilayer body 110 from first end surface 115 to first major surface 111, second major surface 112, first side surface 113, and second side surface 114. First external electrode 120 is electrically connected to first internal electrode layer 151.

Second external electrode 130 is formed on the entirety of second end surface 116 of multilayer body 110 and is also formed to wrap around multilayer body 110 from second end surface 116 to first major surface 111, second major surface 112, first side surface 113, and second side surface 114. Second external electrode 130 is electrically connected to second internal electrode layer 152.

First and second external electrodes 120 and 130 include, for example, an underlying electrode layer and a plating layer disposed on the underlying electrode layer. The underlying electrode layer includes at least one of layers such as a baked electrode layer, a resin electrode layer, or a thin film electrode layer.

The baked electrode layer is a layer including glass and metal, and may be a single layer or a plurality of layers. The baked electrode layer may include, for example, one type of metal including Ni, Cu, Ag, Pd or Au, or an alloy including that metal, and for example, may include an alloy of Ag and Pd or the like.

The baked electrode layer is formed by applying a conductive paste including glass and metal to multilayer body 110 and baking the conductive paste. The baking may be performed at the same time as multilayer body 110 is fired, or may be performed after multilayer body 110 is fired. The baked electrode layer preferably has a maximal thickness having a dimension of about 20 μm or more and about 70 μm or less, for example.

The resin electrode layer can be formed, for example, as a layer including conductive particles and a thermosetting resin. When forming the resin electrode layer, the baked electrode layer may not be formed and the resin electrode layer may directly be formed on the multilayer body. The resin electrode layer may be a single layer or a plurality of layers. The resin electrode layer preferably has a maximal thickness having a dimension of about 20 μm or more and about 70 μm or less, for example.

The thin film electrode layer is, for example, a layer of about 1 μm or less in which metal particles are deposited, and can be formed in a known thin film forming method such as sputtering or vapor deposition.

The plating layer on the underlying electrode layer may include, for example, one type of metal including Ni, Cu, Ag, Pd or Au, or an alloy including that metal, and may include, for example, an alloy of Ag and Pd or the like. The plating layer may be a single layer or a plurality of layers. However, the plating layer preferably has a two-layer structure in which a Sn plating layer is formed on a Ni plating layer. The Ni plating layer has a function to prevent the underlying electrode layer from being eroded by solder when mounting multilayer ceramic capacitor 100. The Sn plating layer has a function to improve solder wettability when mounting multilayer ceramic capacitor 100. A single plating layer preferably has a thickness having a dimension of 1 μm or more and 5 μm or less.

Multilayer ceramic capacitor 100 has a dimension of about 0.1 mm or more and about 1.0 mm or less in lengthwise direction L, for example. Multilayer ceramic capacitor 100 has a dimension of about 0.05 mm or more and about 0.5 mm or less in layer stacking direction T, for example. Multilayer ceramic capacitor 100 has a dimension of about 0.05 mm or more and about 0.5 mm or less in widthwise direction W, for example. The above dimensions include tolerances.

As shown in FIG. 3, in a cross section of multilayer body 110 taken along layer stacking direction T and widthwise direction W at a middle portion of the multilayer body in lengthwise direction L, the plurality of internal electrode layers 150 each include opposite ends in widthwise direction W with one opposite end arcuately curved to include an arcuate portion Y and the other opposite end bent to have a bent portion Z including at least one point of inflection. Note that being arcuate represents a curve having no point of inflection. By polishing multilayer body 110 to the middle portion in lengthwise direction L and observing an exposed cross section, the arcuately curved arcuate portion Y can be confirmed.

The plurality of internal electrode layers 150 include a type-A internal electrode layer 150A including one end in widthwise direction W with arcuate portion Y, and a type-B internal electrode layer 150B including one end in widthwise direction W with bent portion Z.

In the present example embodiment, the plurality of internal electrode layers 150 include type-A internal electrode layer 150A and type-B internal electrode layer 150B positioned alternately in layer stacking direction T, type-A internal electrode layer 150A and type-B internal electrode layer 150B each being a single layer.

The plurality of internal electrode layers 150 have a maximal offset amount D1 of about 20 μm or less in widthwise direction W, for example. Specifically, of the plurality of internal electrode layers 150, internal electrode layer 150 located closest to first side surface 113 and internal electrode layer 150 located closest to second side surface 114 have maximal offset amount D1 of about 20 μm or less in widthwise direction W, for example.

Hereinafter, a non-limiting example of a method for manufacturing multilayer ceramic capacitor 100 according to the present example embodiment will be described.

In the method for manufacturing multilayer ceramic capacitor 100, initially, a ceramic slurry including ceramic powder, a binder, and a solvent is prepared. The ceramic slurry is formed into a sheet on a carrier film by using a die coater, a gravure coater, a microgravure coater, or the like, to produce an inner layer ceramic green sheet and an outer layer ceramic green sheet, which will be described hereinafter.

The outer layer ceramic green sheet may be formed of a material identical to that of the inner layer ceramic green sheet, or may be formed of a material including an ingredient different from a material of the inner layer ceramic green sheet.

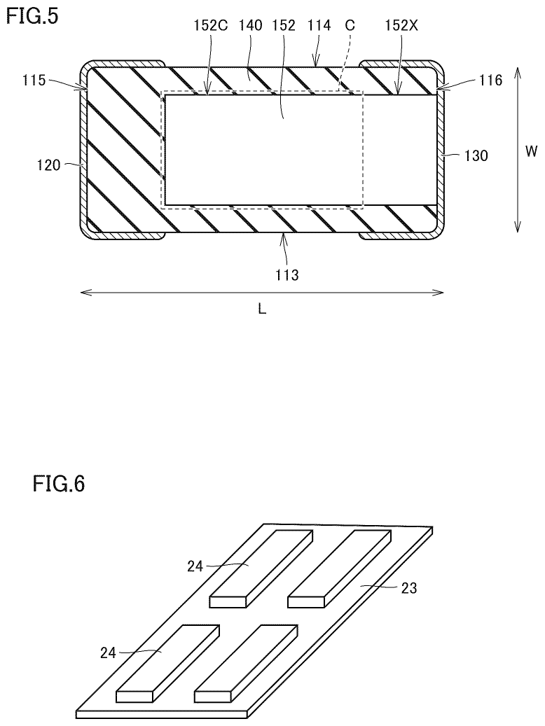

FIG. 6 is a perspective view of an appearance of an inner layer ceramic green sheet with a conductive pattern formed thereon to serve as a raw material sheet in a method for manufacturing a multilayer ceramic capacitor according to the first example embodiment of the present invention.

As shown in FIG. 6, a conductive paste is printed on inner layer ceramic green sheet 23 by screen printing, inkjet printing, gravure printing, or the like so as to have a strip-shaped pattern to form a conductive pattern 24. Specifically, conductive pattern 24 in the form of a rectangle or approximate rectangle including two sides extending in widthwise direction W and two sides extending in lengthwise direction L is printed on one major surface of inner layer ceramic green sheet 23. The conductive paste includes Ni powder, an organic solvent, a binder and the like.

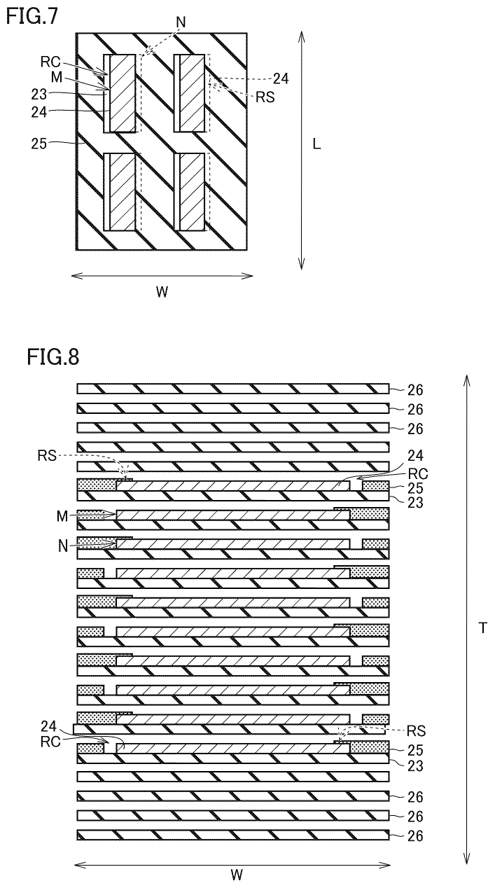

FIG. 7 is a plan view of an appearance of an inner layer ceramic green sheet with a dielectric pattern formed thereon to serve as a raw material sheet in the method for manufacturing the multilayer ceramic capacitor according to the first example embodiment of the present invention.

As shown in FIG. 7, on one major surface of inner layer ceramic green sheet 23, a dielectric pattern 25 is formed by applying a dielectric paste to surround conductive pattern 24 so as to form an overlapping region RS overlapping one side N of the two sides of conductive pattern 24 extending in lengthwise direction L and a spacing region RC spacing the dielectric pattern in widthwise direction W from another one side M of the two sides of conductive pattern 24 extending in lengthwise direction L. The dielectric paste may include at least one of Mg, Mn, or Si more than a material used for the inner layer ceramic green sheet.

In widthwise direction W, overlapping region RS and spacing region RC each have a width having a dimension of about 20 μm or more and about 30 μm or less, for example. Dielectric pattern 25 may be formed before conductive pattern 24 is formed. In that case, conductive pattern 24 is superimposed on dielectric pattern 25 in overlapping region RS.

In this manner, inner layer ceramic green sheet 23, which will serve as dielectric layer 140 located in inner layer portion C, has one major surface with conductive pattern 24, which will serve as internal electrode layer 150, and dielectric pattern 25 printed thereon, i.e., a raw material sheet is prepared.

FIG. 8 shows an outer layer ceramic green sheet and the raw material sheet stacked in layers in the method for manufacturing the multilayer ceramic capacitor according to the first example embodiment of the present invention.

As shown in FIG. 8, a plurality of raw material sheets and outer layer ceramic green sheet 26 are stacked in layers. Specifically, the raw material sheet shown in FIG. 7 is stacked in layers such that the layers are alternately offset by a predetermined distance in lengthwise direction L. When this is done, a plurality of raw material sheets are stacked in layers such that, while the plurality of raw material sheets are stacked in layers such that conductive pattern 24 has widthwise W opposite ends overlapping those of another conductive pattern, the plurality raw material sheets include raw material sheets having one side N and the other side M overlapping each other.

In the present example embodiment, the plurality of raw material sheets are stacked in layers such that one side N and the other side M overlap each other at the location of one end of conductive pattern 24 in widthwise direction W alternately every layer of the plurality of raw material sheets. A plurality of outer layer ceramic green sheets 26 are stacked in layers on those sides of the stacked plurality of raw material sheets which are opposite in layer stacking direction T. That is, the plurality of raw material sheets are stacked in layers while the sheets are alternately rotated by 180 degrees in an in-plane direction of one major surface of inner layer ceramic green sheet 23. As a result, overlapping region RS and spacing region RC are alternately arranged for each raw material sheet in layer stacking direction T.

The stacked outer layer ceramic green 26 and raw material sheets are thermocompression-bonded to form a mother block. When this is done, conductive pattern 24 located in overlapping region RS is gently curved in an arc toward one side in layer stacking direction T. A portion of conductive pattern 24 in contact with spacing region RC is bent to have a portion curved to project toward one side in layer stacking direction T and a portion curved to project toward the other side in layer stacking direction T successively in widthwise direction W and thus has a point of inflection. As overlapping region RS and spacing region RC are alternately arranged in layer stacking direction T, arcuate portion Y and bent portion Z are alternately positioned in layer stacking direction T, as shown in FIG. 3. This can prevent arcuate portion Y from being stacked in layers excessively successively in layer stacking direction T and prevent bent portion Z from being stacked in layers excessively successively in layer stacking direction T, and hence prevent a structural defect.

The mother block is individualized into a plurality of multilayer chips with a press-cutting blade or the like. The multilayer chip is heated to have a ceramic material sintered, and is subsequently barrel-finished to form multilayer body 110. A conductive paste is applied to each of first and second end surfaces 115 and 116 of multilayer body 110 to form a metal layer which is in turn baked and thereafter plated with Ni followed by Sn to form first and second external electrodes 120 and 130.

Multilayer ceramic capacitor 100 according to the present example embodiment can be manufactured through the series of steps described above.

Multilayer ceramic capacitor 100 according to the present example embodiment, in a cross section taken along layer stacking direction T and widthwise direction W at a middle portion of multilayer body 110 in lengthwise direction L, includes the plurality of internal electrode layers 150 arranged such that each internal electrode layer includes opposite ends in widthwise direction W with one opposite end arcuately curved to include arcuate portion Y and the other opposite end bent to include bent portion Z including at least one point of inflection. The plurality of internal electrode layers 150 include type-A internal electrode layer 150A including one end in widthwise direction W with arcuate portion Y, and type-B internal electrode layer 150B including one end in widthwise direction W with bent portion Z. This can prevent multilayer ceramic capacitor 100 from having a structural defect.

Multilayer ceramic capacitor 100 according to the present example embodiment includes the plurality of internal electrode layers 150 with type-A internal electrode layer 150A and type-B internal electrode layer 150B positioned alternately in layer stacking direction T, type-A internal electrode layer 150A and type-B internal electrode layer 150B each being a single layer. This can effectively prevent multilayer ceramic capacitor 100 from having a structural defect.

Multilayer ceramic capacitor 100 according to the present example embodiment includes the plurality of internal electrode layers 150 with maximal offset amount D1 of about 20 μm or less in widthwise direction W, for example. This allows arcuate portion Y and bent portion Z to reliably overlap each other in layer stacking direction T to prevent a structural defect.

### Second Example Embodiment

Hereinafter, a multilayer ceramic capacitor according to a second example embodiment of the present invention will be described with reference to the drawings. The multilayer ceramic capacitor according to the second example embodiment of the present invention has a configuration similar to that of multilayer ceramic capacitor 100 according to the first example embodiment of the present invention, except that the former differs from the latter in that type-A internal electrode layer 150A and type-B internal electrode layer 150B are alternately stacked in layers, type-A internal electrode layer 150A and type-B internal electrode layer 150B each being a plurality of layers, and accordingly, the similar configuration will not be described repeatedly.

FIG. 9 shows a multilayer ceramic capacitor according to the second example embodiment of the present invention in a cross section taken along a layer stacking direction and a widthwise direction at a middle portion in a lengthwise direction. As shown in FIG. 9, a multilayer ceramic capacitor 200 according to the second example embodiment of the present invention includes the plurality of internal electrode layers 150 with type-A internal electrode layer 150A and type-B internal electrode layer 150B disposed alternately in layer stacking direction T, type-A internal electrode layer 150A and type-B internal electrode layer 150B each being a plurality of layers. In the example shown in FIG. 9, five type-A internal electrode layers 150A and five type-B internal electrode layers 150B are alternately disposed in layer stacking direction T. This can prevent multilayer ceramic capacitor 200 from having a structural defect.

The plurality of internal electrode layers 150 include a plurality of layers with a maximal offset amount D2 of about 10 μm or less in widthwise direction W, for example. In the example shown in FIG. 9, the five type-A internal electrode layers 150A have maximal offset amount D2 of about 10 μm or less in widthwise direction W, and the five type-B internal electrode layers 150B have maximal offset amount D2 of about 10 μm or less in widthwise direction W, for example. The five type-A internal electrode layers 150A and the five type-B internal electrode layers 150B for a total of ten internal electrode layers 150 have a maximal offset amount of about 20 μm or less in widthwise direction W, for example. This allows arcuate portion Y and bent portion Z to be reliably overlap each other in layer stacking direction T to prevent a structural defect.

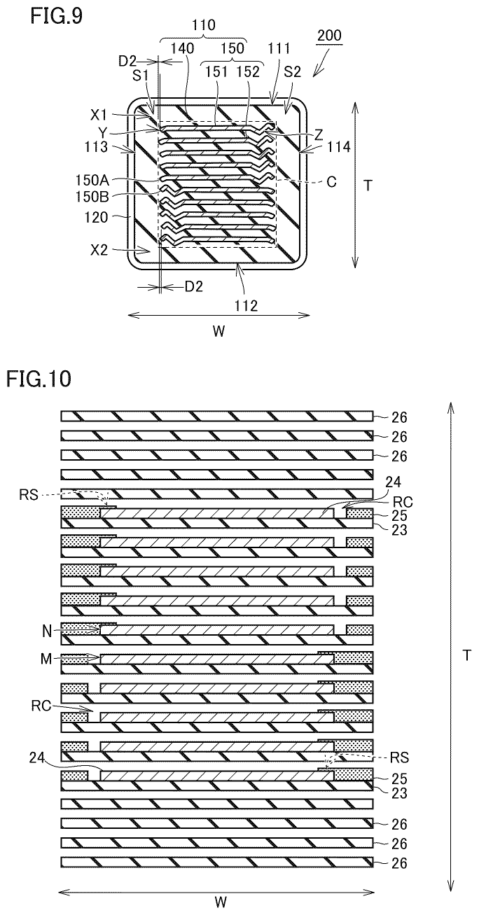

FIG. 10 shows an outer layer ceramic green sheet and a raw material sheet stacked in layers in a method for manufacturing a multilayer ceramic capacitor according to the second example embodiment of the present invention.

As shown in FIG. 10, a plurality of raw material sheets and outer layer ceramic green sheet 26 are stacked in layers. Specifically, the raw material sheet shown in FIG. 7 is stacked in layers such that the layers are alternately offset by a predetermined distance in lengthwise direction L. When this is done, the plurality of raw material sheets are stacked in layers such that one side N and the other side M overlap each other at the location of one end of conductive pattern 24 in widthwise direction W alternately for each of the plurality of layers of the plurality of raw material sheets. In the example shown in FIG. 10, the plurality of raw material sheets are stacked in layers such that one side N and the other side M overlap each other at the location of one end of conductive pattern 24 in widthwise direction W alternately every five layers. Thus, overlapping region RS and spacing region RC are alternately arranged every five raw material sheets in layer stacking direction T.

The present example embodiment eliminates the necessity of rotating a raw material sheet by 180 degrees whenever depositing the sheet, and allows a plurality of raw material sheets to be stacked in layers in a shorter period of time than the first example embodiment.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers and a plurality of internal electrode layers that are stacked in a layer stacking direction, and including a first major surface and a second major surface opposite to each other in the layer stacking direction, a first side surface and a second side surface opposite to each other in a widthwise direction orthogonal to the layer stacking direction, and a first end surface and a second end surface opposite to each other in a lengthwise direction orthogonal to both the layer stacking direction and the widthwise direction; and
an external electrode on each of the first and second end surfaces and connected to the plurality of internal electrode layers; wherein
in a cross section of the multilayer body taken along the layer stacking direction and the widthwise direction at a middle portion of the multilayer body in the lengthwise direction, the plurality of internal electrode layers each include opposite ends in the widthwise direction including one opposite end arcuately curved to include an arcuate portion and the other opposite end bent to include a bent portion including at least one point of inflection; and
the plurality of internal electrode layers include a type-A internal electrode layer including one end in the widthwise direction with the arcuate portion, and a type-B internal electrode layer including the one end in the widthwise direction with the bent portion.

2. The multilayer ceramic capacitor according to claim 1, wherein the plurality of internal electrode layers include the type-A internal electrode layer and the type-B internal electrode layer alternately positioned in the layer stacking direction, the type-A internal electrode layer and the type-B internal electrode layer each being a single layer.

3. The multilayer ceramic capacitor according to claim 1, wherein the plurality of internal electrode layers include the type-A internal electrode layer and the type-B internal electrode layer alternately positioned in the layer stacking direction, the type-A internal electrode layer and the type-B internal electrode layers each being a plurality of layers.

4. The multilayer ceramic capacitor according to claim 1, wherein the plurality of internal electrode layers have a maximal offset amount of about 20 μm or less in the widthwise direction.

5. The multilayer ceramic capacitor according to claim 3, wherein the plurality of internal electrode layers include the plurality of layers with a maximal offset amount of about 10 μm or less in the widthwise direction.

6. The multilayer ceramic capacitor according to claim 1, wherein the multilayer body includes rounded corners and rounded ridges.

7. The multilayer ceramic capacitor according to claim 1, wherein the external electrode includes an underlying electrode layer and a plating layer on the underlying electrode layer.

8. The multilayer ceramic capacitor according to claim 7, wherein the underlying electrode layer includes at least one of a baked electrode layer, a resin electrode layer, or a thin film electrode layer.

9. The multilayer ceramic capacitor according to claim 1, wherein the multilayer ceramic capacitor has a dimension of about 0.1 mm or more and about 1.0 mm or less in the lengthwise direction, a dimension of about 0.05 mm or more and about 0.5 mm or less in the layer stacking direction, and a dimension of about 0.05 mm or more and about 0.5 mm or less in the widthwise direction.

10. The multilayer ceramic capacitor according to claim 3, wherein five of the type-A internal electrode layers and five of the type-B internal electrode layers are alternately positioned in the layer stacking direction.

11. The multilayer ceramic capacitor according to claim 10, wherein the five type-A internal electrode layers have a maximal offset amount of about 10 μm or less in the widthwise direction, and the five type-B internal electrode layers have a maximal offset amount of about 10 μm or less in the widthwise direction.

12. The multilayer ceramic capacitor according to claim 10, wherein the five type-A internal electrode layers and the five type-B internal electrode layers have a maximal offset amount of about 20 μm or less in the widthwise direction.

13. A method for manufacturing a multilayer ceramic capacitor, the method comprising:
preparing a plurality of ceramic green sheets;
forming a conductive pattern on one major surface of each of the plurality of ceramic green sheets, the conductive pattern including two sides extending in a widthwise direction and two sides extending in a lengthwise direction;
forming a dielectric pattern on the one major surface of each of the plurality of ceramic green sheets such that, while the dielectric pattern surrounds the conductive pattern, an overlapping region and a spacing region are formed, the overlapping region overlapping one of the two sides of the conductive pattern extending in the lengthwise direction, the spacing region spacing the dielectric pattern in the widthwise direction from another one of the two sides of the conductive pattern extending in the lengthwise direction; and
stacking the plurality of ceramic green sheets in layers such that, while the plurality of ceramic green sheets are stacked in layers such that the conductive pattern has opposite ends in the widthwise direction overlapping ends of another conductive pattern, the plurality of ceramic green sheets include ceramic green sheets with the one side and the other side overlapping each other.

14. The method according to claim 13, wherein, in the stacking the plurality of ceramic green sheets in layers, the one side and the other side overlap each other at a location of one end of the conductive pattern in the widthwise direction alternately for each of the layers of the plurality of ceramic green sheets.

15. The method according to claim 13, wherein, in the stacking the plurality of ceramic green sheets in layers, the one side and the other side overlap each other at a location of one end of the conductive pattern in the widthwise direction alternately for each of the layers of the plurality of ceramic green sheets.

16. The method according to claim 13, wherein the multilayer ceramic capacitor has a dimension of about 0.1 mm or more and about 1.0 mm or less in the lengthwise direction, a dimension of about 0.05 mm or more and about 0.5 mm or less in the layer stacking direction, and a dimension of about 0.05 mm or more and about 0.5 mm or less in the widthwise direction.

17. The method according to claim 14, wherein five of the type-A internal electrode layers and five of the type-B internal electrode layers are alternately positioned in the layer stacking direction.

18. The multilayer ceramic capacitor according to claim 17, wherein the five type-A internal electrode layers have a maximal offset amount of about 10 μm or less in the widthwise direction, and the five type-B internal electrode layers have a maximal offset amount of about 10 μm or less in the widthwise direction.

19. The multilayer ceramic capacitor according to claim 17, wherein the five type-A internal electrode layers and the five type-B internal electrode layers have a maximal offset amount of about 20 μm or less in the widthwise direction.
